(19) United States
(12) Patent Application Publication
(10) Pub. No.: US 2017/0335644 A1
(43) Pub. Date: Nov. 23, 2017

(54) SMART FRAC BALL

(71) Applicant: GAS TECHNOLOGY INSTITUTE, DES PLAINES, IL (US)

(72) Inventor: Jordan CIEZOBKA, Addison, IL (US)

(73) Assignee: GAS TECHNOLOGY INSTITUTE, DES PLAINES, IL (US)

(21) Appl. No.: 15/600,168

(22) Filed: May 19, 2017

Related U.S. Application Data
(60) Provisional application No. 62/339,243, filed on May 20, 2016.

(51) Int. Cl. E21B 23/10; E21B 47/04; B29C 70/46; B29L 31/54

(52) U.S. Cl. CPC E21B 23/10; E21B 47/04; B29C 70/462; B29L 2031/54

(57) ABSTRACT

A frac stage isolation device including instruments for measuring pressure, temperature, salinity, pH, electromagnetic waves and/or other physical parameters such as vibrations from acoustic energy emissions during a hydraulic fracturing process. The frac stage isolation device blocks a flow passage in a frac plug to isolate a previously fracked section of a wellbore. The frac stage isolation device may also be used without a frac plug in applications requiring data acquisition.

### CROSS REFERENCE TO RELATED APPLICATION

This application claims the benefit of U.S. Provisional Patent Application, Serial No. 62/339,243, filed on 20 May 2016. The co-pending Provisional Application is hereby incorporated by reference herein in its entirety and is made a part hereof, including but not limited to those portions which specifically appear hereinafter.

### BACKGROUND OF THE INVENTION

### Field of the Invention

This invention relates generally to a device for use in a wellbore during hydraulic fracturing. More specifically, this invention relates to a device for isolating a section of a wellbore and monitoring and/or measuring physical parameters of the wellbore including, but not limited to, pressure, temperature, and/or other physical parameters such as vibrations from acoustic energy emissions, microseismic emissions.

### Discussion of Related Art

Known devices for isolating a section of a wellbore include frac balls, such as the frac ball described in U.S. Patent Application Publication No. 2012/0234538. These known frac balls include a generally spherical construction and are made of various materials capable of withstanding high temperatures and pressures of the fracturing process, including but not limited to, resin, glass fibers, and/or carbon fibers. These known frac balls are capable of plugging an opening in a frac plug to isolate a section of a wellbore. However, these known frac balls are inactive and cannot monitor and/or measure physical parameters of the wellbore.

Traditionally, methods used to acquire bottom hole parameters including pressure and temperature data include behind-the-pipe fiber optic cables, bottom hole pressure gages in vertical wells, horizontal, or any well, and live annuli surface measurements. Although current technology exists that can capture this information, it is either prohibitively expensive or inadequate in the current horizontal well environment.

### SUMMARY OF THE INVENTION

The subject invention is a frac stage isolation device that includes on-board instruments for measuring pressure, temperature, salinity, pH, electromagnetic waves, and/or other physical parameters such as vibrations from acoustic energy emissions (microseismic emissions).

In a preferred embodiment, the frac stage isolation device comprises a frac ball that seals a frac plug and records data during hydraulic fracturing. In this embodiment, the frac ball comprises a spherical shape, however, it should be understood that the frac ball is not limited to a spherical shape and may comprise any shape that can couple to the frac plug interrupting a flow cavity in the frac plug.

In a preferred embodiment of this invention, the frac stage isolation device comprises spherical housing with one or more sensors positioned within the housing for measuring at least one of pressure, temperature, and/or vibrations during hydraulic fracturing. In an embodiment of this invention, pressure can be measured with a pressure transducer mounted close to a surface of the housing. In an alternative embodiment, the pressure transducer or another sensor may be positioned near a center of the housing and the frac stage isolation device may include an aperture, for example a pinhole, extending from a surface of the housing to the sensor to improve data measurement of some types of sensors positioned near a center of the frac ball. The frac stage isolation device may also include other sensors including a geophone, a MEMS Pressure/Temperature (P/T) sensor, a MEMS accelerometer, and/or a surface strain gage. However, the system of this invention is not limited to these types of sensors. The frac stage isolation device may further include memory and/or processor for storing data collected by the sensor. The frac stage isolation device preferably further includes a transmitter and/or receiver for wirelessly transmitting data collected by the sensor.

In operation, the method of isolating a section of a wellbore with the frac stage isolation device and monitoring physical parameters of the wellbore begins by setting a frac plug along a length of the wellbore with a plug and gun assembly. The frac plug preferably sealingly engages a wall of the wellbore to partially block flow to a downwell portion of the wellbore. The frac plug includes a flow passage extending through the frac plug and a frac plug seat positioned at one end of the flow passage. The plug and gun assembly then creates a plurality of new perforations in the casing. The plug and gun assembly is then removed from the wellbore. The method of this invention then includes sealing the flow passage in the frac plug with the frac stage isolation device positioned on the frac plug seat. Sealing the flow passage isolates previously formed perforations on a flow side of the frac plug, forcing a fracturing fluid to enter the new set of perforations. However, in some cases, the frac stage isolation device may not seal the frac plug but will still be able to record usable data. In a preferred embodiment the frac stage isolation device includes sensors to measuring data comprising at least one of pressure, temperature, and vibrations with the sensors in the frac stage isolation device during hydraulic fracturing. This process may be repeated along an entire length of the wellbore for up to 30 times or more.

Once hydraulic fracturing is completed for each frac stage, the data from the frac ball is recovered wirelessly or by physically recovering the frac ball through flow back or through intervention techniques, such as fishing. In an alternative embodiment, the data may be recovered wirelessly by the plug and gun assembly when the plug and gun assembly is conveyed to the desired well depth between each fracture stage.

Measuring downhole pressure is very important as it allows for determining fracturing pressure without any of the pipe friction components, thus providing very accurate fracturing pressures. Acquiring downhole pressure and temperature measurements during hydraulic fracturing using previously known methods is prohibitively expensive and rarely done. The device of this invention can capture downhole pressure and temperature data with minimal cost and does not require wellbore construction modifications or additions of any cables, either fiber optic or copper conductor.

The device of this invention may be also used in other applications where isolation and data acquisition are required. Such applications include, but are not limited to, geothermal reservoirs requiring water shearing, re-fracturing treatments, secondary and tertiary recovery methods including water and other CO₂ flooding. Other instances where the device of this invention can be used is during drilling or cementing operations. In some embodiments, the device ball is dropped down a tubing (either coiled tubing or jointed pipe) to activate a mechanism of a tool to perform some function or release it from the tubing when the tool is stuck in the wellbore. The device mechanically activates the mechanism or divert flow with the tool. If the parameters of the environment where the tool was stuck can be recorded, it may help in diagnosing and preventing future failure incidents.

### BRIEF DESCRIPTION OF THE DRAWINGS

These and other objects and features of this invention will be better understood from the following detailed description taken in conjunction with the following drawings.

FIG. 1 is a cross sectional side view of a frac stage isolation device according to one embodiment of this invention.

FIG. 2 is a schematic diagram showing a plug and perf hydraulic fracturing process where a first stage of a wellbore has been fracked

FIG. 3 is a schematic diagram showing the plug and perf hydraulic fracturing process where a perforation assembly has been positioned to perforate a second section of the wellbore.

FIG. 4. is a schematic diagram showing the plug and perf hydraulic fracturing process with a frac plug and a frac ball in place.

FIG. 5 is a close up view of the schematic diagram shown in FIG. 4.

FIG. 6 is a schematic diagram showing the plug and perf hydraulic fracturing process as the frac ball is withdrawn from the well.

FIG. 7 is a schematic diagram showing data being wireless transmitted between a gun and plug setting tool and the frac ball of this invention.

FIG. 8 is another schematic diagram showing data being wireless transmitted between the gun and plug setting tool and the frac ball of this invention.

FIG. 9 is a schematic diagram showing data being wireless transmitted between the gun and plug setting tool and frac balls of this invention.

### DETAILED DESCRIPTION

The invention of this application is a device and method for isolating a section of a wellbore 100 and also collecting data, such as, pressure, temperature, salinity, pH, electromagnetic radiation, vibrations, and/or other physical parameters during a fracturing process.

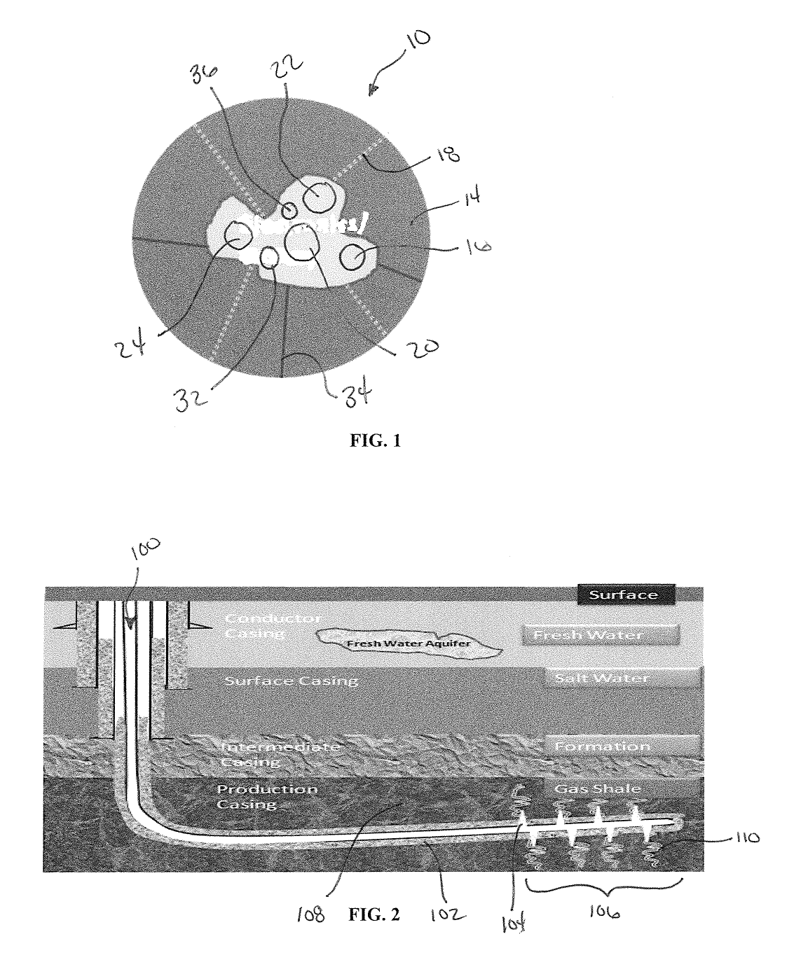

As shown in FIG. 1, the method of this invention includes a frac stage isolation device 10, also known as a frac ball, for blocking flow of fluid through a frac plug 12 in order to isolate a previously fractured section of a well bore while also measuring data including, for example, pressure, temperature, salinity, pH, electromagnetic waves, and/or other physical parameters such as vibrations, during a hydraulic fracturing process. In the embodiment of FIG. 1, the frac stage isolation device 10 comprises a spherical shape manufactured of a plastic resin capable of withstanding temperatures, pressures and forces that are subjected during the fracturing process. Alternatively, the frac stage isolation device 10 may comprises any other shape necessary to block fluid flow through the frac plug 12 any may be manufactured of any material capable of withstanding the hydraulic fracturing process.

In an alternative embodiment of this invention, the frac ball 10 may operate to measure characteristics, such as, pressure, temperature, salinity, pH, electromagnetic radiation, or vibrations, without the frac plug 12. Such as, when device of this invention is used in other applications, including, but not limited to, geothermal reservoirs requiring water sharing, re-fracturing treatments, secondary and tertiary recovery methods including water and other CO₂ flooding.

In the embodiment shown in FIG. 1, the frac ball 10 includes a housing 14 that allows for sensors 16, a battery, and other electronics to be placed inside the ball to monitor certain physical parameters such as pressure and temperature. The sensors, the battery and the other electronics may be connected with a wired or wireless connection. In an embodiment of this invention, pressure is monitored through a pressure transducer or a strain gage mounted close to the surface of the frac ball 10. Alternatively, the housing 14 may include an aperture 18 that leads from a surface of the housing to a pressure transducer or a strain gage positioned in proximity to a center of the housing. In this embodiment, the aperture 18 comprising a narrow, pin hole like, opening in the housing, however the aperture 18 may comprise another type of opening that places the pressure transducer or strain gage in communication with a surface of the housing. In another embodiment, a surface of the frac ball 10 may operate as a strain gage to monitor pressure. The frac ball 10 of this invention may also include other type of sensors, including, but not limited to, a geophone, a MEMS Pressure/Temperature sensor, and/or a MEMS accelerometer. The frac ball 10 may further include an activation sensor 36 that initiates automatic recordation of data when the frac ball 10 is in the wellbore. The activation sensor 36 may activate automatic recordation of data when the frac ball 10 reaches a desired depth of the well based on crossing a temperature, a pressure and/or a fluid conductivity threshold. For example, the frac ball 10 may start measuring and/or recording data when pressure of 1,000 psi is encountered. The frac stage isolation device 10 preferably also includes other electronics including a memory 20, a processor 22, and a wireless transmitter 24 and or receiver 32. In an embodiment of this invention, the frac stage isolation device 10 may also include joints 34 or a hatch to allow a user to access the sensors and other components positioned within the housing 14.

FIG. 2 shows an example of a well comprising the wellbore 100 with a casing 102 cemented therein. In operation, a perforation assembly may be used to create perforations 104 in the casing 102 and cement. FIG. 2 shows an example of a hydraulic fracturing operation where a first section 106 of the wellbore 100 is stimulated, or hydraulically fractured. Fracturing fluid travels through the wellbore 100, then through an open set of perforations 104 and then into a hydrocarbon bearing gas shale 108, thus creating hydraulic fractures 110.

As shown in FIG. 3, after the first section 106 of the wellbore 100 is fractured, the frac plug 12 is set in the casing 102 just before the last perforation in the first section 18. After the frac plug 12 is set, perforating guns shoot a new set perforations 104 in a second section 122 of the wellbore 100. The frac plug 12 is used to partially block flow to the first section 106 of the wellbore 100. In a preferred embodiment, the frac plug 12 includes a flow passage 22 extending through a body of the frac plug 12 to allow fracturing fluid to flow through the frac plug 12. This flow passage 26 allows for fracturing fluid to be pumped through the plug, or fluid recovered from previous sections of the wellbore 100. Even with the frac plug set, there is communication with the first section 106 of perforations 104 and a surface of the well.

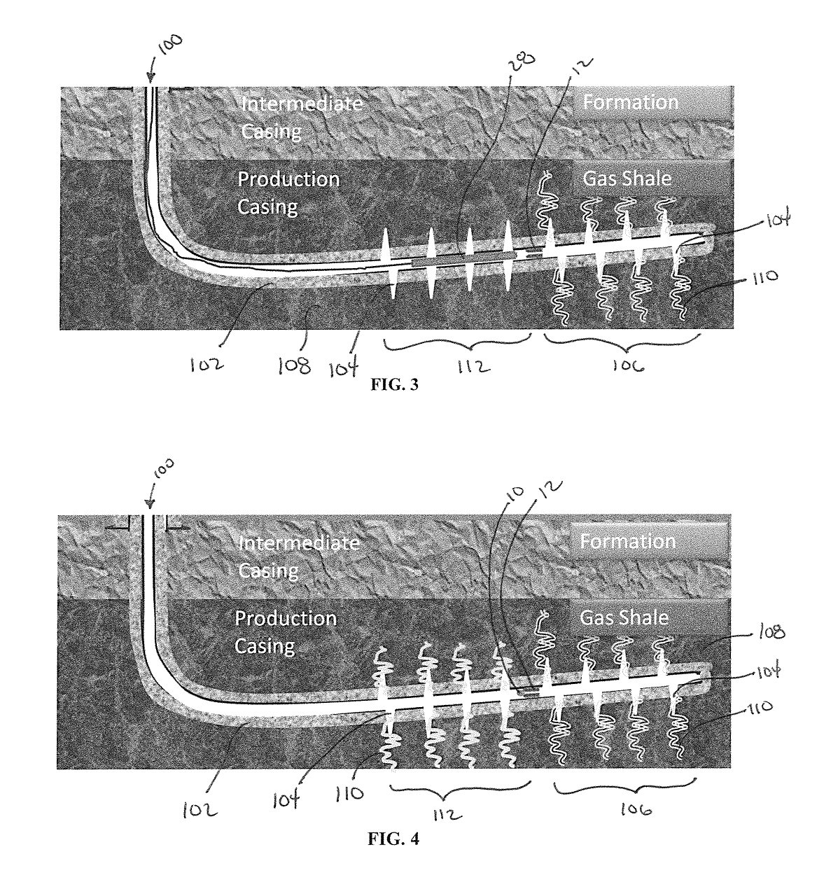

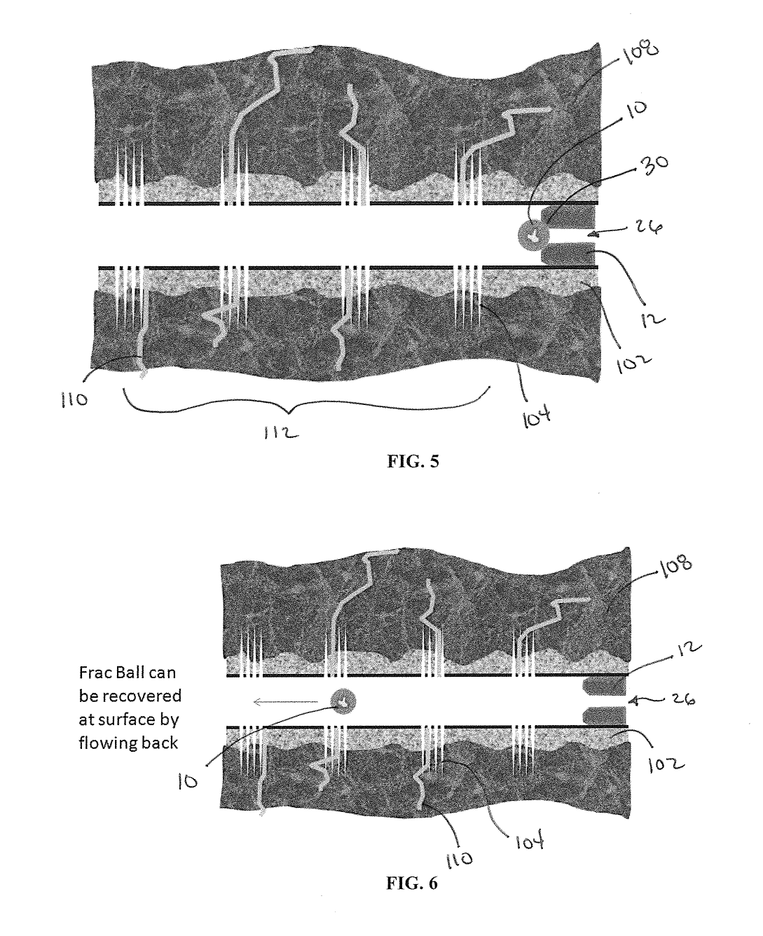

As shown in FIGS. 4 and 5, the gun and plug setting tool 28 is then pulled out of the wellbore 100 and the frac stage isolation device 10 is dropped in to seal off the flow passage 26 in the frac plug 12. One primary function of the frac ball 10 according to the subject invention is to land on a frac plug ball seat 30 on the frac plug 12 to create a pressure tight seal that hydraulically isolates a previous fractured stage or portion of the wellbore 100. The frac stage isolation device 10 isolates all the perforations down the flow side of the plug 12 and forces fracturing fluid to enter a new set of perforations in the second section 112. This process may be repeated many times, until the entire horizontal lateral portion of the wellbore 100 is stimulated. There could be over 30 stages pumped in a single wellbore.

The frac ball seat 30 and the flow passage 26 are typically large enough to avoid a large flow restriction. Therefore, a diameter of the frac ball 10 has to be larger than the ball seat diameter. In a typical plug and perf application, the frac ball size is about 2.5-3 inches in diameter. However, in alternative embodiments, the frac ball 10 may be sized as appropriate to seal any size frac plug 12.

Once a seal is created, fluid is injected into the new set of perforations 104 in the second section 112 that have previously been created. In the event that no flow can be maintained in the new section of the wellbore, the well can be reverse flowed, as in flowing fluid from the formation, through the old set of perforations, through the wellbore, and back to surface. Thus, as shown in FIG. 6, the frac ball 10 that has been previously seated on the ball seat 30 has the ability to come off the ball seat when the flow is reversed. In essence the frac ball 10 acts like a check valve, where fluid can only be flowed in one direction.

Since the frac ball 10 remains in the wellbore 100 during the entire fracturing process, the frac ball 10 is exposed to the pressures and temperatures that exist in the wellbore 100 during the fracturing process. Measuring downhole pressure is very important as it allows for determining fracturing pressure without any of the pipe friction components, thus providing very accurate fracturing pressures. In most plug and perf applications, measuring bottomhole pressure is not possible because a second wire and sensor would have to be present in the wellbore throughout the treatment. The frac ball 10 with electronics according to this invention could record these parameters for later recovery and could also allow determination of fluid loss through the frac plug 12, due to a poor seal with the frac ball 10 or some other condition, such as poor seal on the outside of the plug. Pressure measurement could allow determination of fluid loss to prior stage by measuring pressure in all directions. Or the ability for spatial and temporal discrete pressure measurements. Pressure outside of the frac plug 12, the second section 112, indicates pressure of current frac stage, while pressure inside of the frac plug 12, the first section 106, reveals how well the frac ball 10 and the frac plug 12 are sealing. If the pressure inside the frac plug 12 is much lower, then there is a perfect seal and indicated pressure of isolated formation. If the seal is poor or nonexistent, the pressure inside the frac plug 12 and outside of the frac plug 12 will be the same. In this event, there may be much or no flow though the frac plug.

Temperature measurement around the frac ball 10 will allow determination of how much fluid is being passed through a poorly sealed ball.

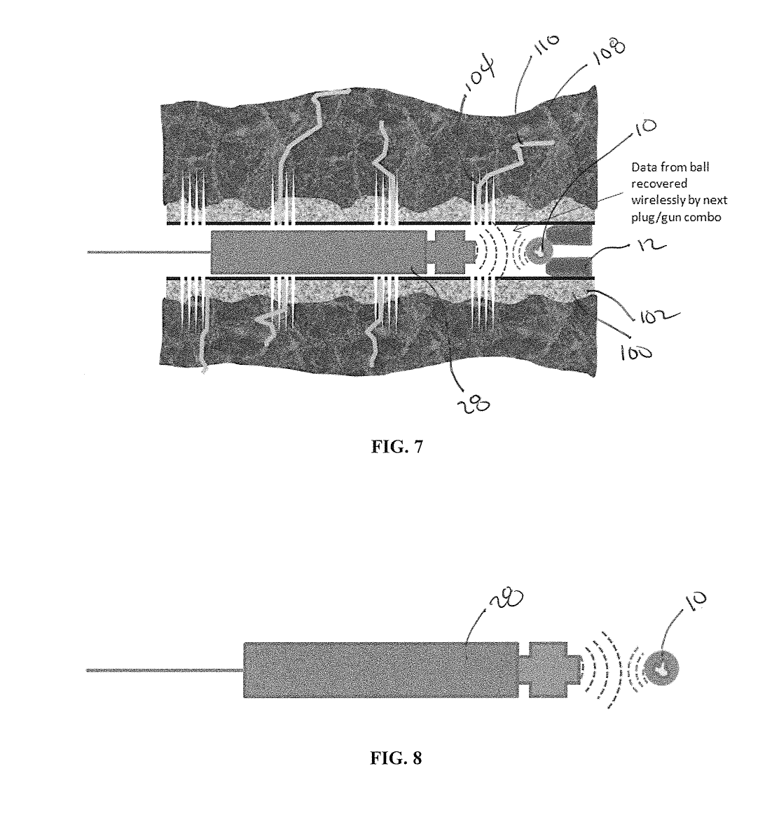

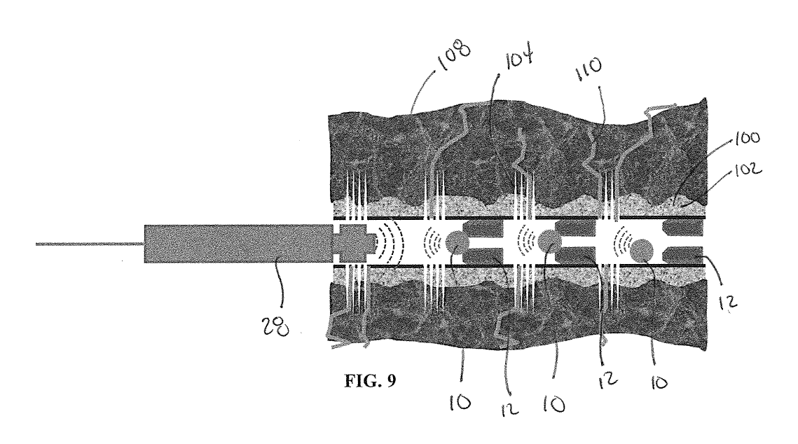

In an embodiment of this invention, the frac ball 10 may be recovered after each fracture stage is pumped and measured data could be downloaded either wirelessly, through a wired connection or, alternatively, by opening the housing 14 and retrieving the data using another method. In another embodiment, as shown in FIGS. 7 and 8, data may be recovered wirelessly downhole while the frac ball 10 is still on the frac plug 12 or in the wellbore 100. The tool that is used to download data and communicate with the frac ball is preferably part of the plug and gun assembly 28. The tool is either activated from the surface or due to proximity with ball and allows for automatic data transfer. FIG. 9 shows another embodiment of this invention where data is transferred between the plug and gun assembly 28 and a plurality of frac balls in a daisy chain data transfer. In this embodiment, a series of frac balls transfer and store data from each other in a sequential or non-sequential pattern and then transfer the data to the plug and gun assembly or to another receiver tool. As shown, the frac ball 10 of this invention may transmit and/or collect data when positioned on the frac plug 12 or when separated from the frac plug 12.

A pressure sensor according to this invention preferably includes enough power to transmit a wireless signal from the sensor to a receiver while overcoming signal attenuation through fluids of various salinity between (0-200,000 ppm Chlorides or more) and various gas content (methane, CO₂. Etc.) Preferably, the frac stage isolation device 10 will transmit data using a signal that has a wavelength that is less than a diameter of the casing 102 or pipe in which it is transmitting.

Thus, the invention provides a smart frac ball for collecting data during a hydraulic fracturing process, providing direct measurement of pressure, temperature, and/or other physical parameters such as vibrations from acoustic energy emissions, microseismic emissions.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

I claim:

1. A frac stage isolation device comprising:
a housing;
a sensor connected to the housing for measuring at least one of pressure, temperature, salinity, pH, electromagnetic radiation, or vibrations in a wellbore; and
wherein the housing couples to a frac plug to block an opening extending through the frac plug to hydraulically isolate a previously fractured stage in the wellbore.

2. The frac stage isolation device of claim 1, wherein the housing comprises a spherical shape.

3. The frac stage isolation device of claim 1, wherein the sensor is positioned within the housing.

4. The frac stage isolation device of claim 1, wherein the sensor includes a pressure transducer mounted in proximity to a surface of the housing.

5. The frac stage isolation device of claim 1 further including an aperture extending from a surface of the housing to the sensor.

6. The frac stage isolation device of claim 1 further including a memory for storing data collected by the sensor.

7. The frac stage isolation device of claim 1 further including a transmitter for wirelessly transmitting data collected by the sensor.

8. The frac stage isolation device of claim 1 further including at least one of a strain gage, a geophone, a MEMS Pressure/Temperature (P/T) sensor, and/or a MEMS accelerometer within the housing.

9. The frac stage isolation device of claim 1 further including an activation sensor for automatically activating the sensor when a threshold wellbore property is exceeded, wherein the threshold wellbore property comprises one of a threshold pressure, a threshold temperature, or a fluid conductivity threshold.

10. A method of isolating or partially isolating a section of a wellbore with a frac stage isolation device and monitoring physical parameters of the wellbore, the method comprising:
positioning a frac plug along a length of the wellbore, wherein the frac plug sealingly engages a casing of the wellbore and includes a flow passage extending through the frac plug and a frac plug seat at one end of the flow passage;
sealing the flow passage with a frac stage isolation device positioned on the frac plug seat, wherein the frac stage isolation device includes one or more sensors;
fracturing a section of the well bore; and
measuring data comprising at least one of pressure, temperature, salinity, pH, electromagnetic radiation, and vibrations with the one or more sensors in the frac stage isolation device during hydraulic fracturing.

11. The method of claim 10, wherein the step of measuring data includes measuring acoustic energy emissions.

12. The method of claim 10, wherein the frac stage isolation device comprises a frac ball.

13. The method of claim 10, further comprises a step of recovering data from the frac stage isolation device wirelessly or by physically recovering the frac stage isolation device through flowback.

14. A frac ball for data acquisition, the frac ball comprising:
a spherical housing; and
a sensor positioned within the housing for measuring wellbore characteristics including at least one of pressure, temperature, salinity, pH, electromagnetic radiation, or vibrations in a wellbore.

15. The frac ball of claim 14, wherein the sensor includes a pressure transducer mounted in proximity to a surface of the spherical housing.

16. The frac ball of claim 14 further including an aperture extending from the surface of the spherical housing to the sensor.

17. The frac ball of claim 14 further including a memory for storing data collected by the sensor.

18. The frac ball of claim 14 further including a transmitter for wirelessly transmitting data collected by the sensor.

19. The frac ball of claim 14 further including at least one of a geophone, a MEMS Pressure/Temperature (P/T) sensor, and/or a MEMS accelerometer within the spherical housing.

20. The frac ball of claim 14 further including an activation sensor for automatically activating the sensor when a threshold wellbore property is exceeded, wherein the threshold wellbore property comprises one of a threshold pressure, a threshold temperature, or a fluid conductivity threshold.
